(19) United States
(12) Patent Application Publication
(10) Pub. No.: US 2026/0331723 A1
(43) Pub. Date: Oct. 22, 2026

(54) SECONDARY BATTERY AND BATTERY MODULE

(71) Applicant: SAMSUNG SDI CO., LTD., Yongin-si, Gyeonggi-do (KR)

(72) Inventor: Kee Yun KIM, Yongin-si, Gyeonggi-do (KR)

(21) Appl. No.: 18/865,723

(22) PCT Filed: Mar. 8, 2024
(86) PCT No.: PCT/KR2024/003060

§ 371 Date: Nov. 14, 2024

(30) Foreign Application Priority Data
Nov. 23, 2023 (KR) 10-2023-0164112

(51) Int. Cl. H01M 50/545; H01M 50/505; H01M 50/55

(52) U.S. Cl. CPC H01M 50/545; H01M 50/505; H01M 50/55

(57) ABSTRACT

Disclosed are a secondary battery and a battery module, and more particularly a terminal plateless secondary battery and a battery module having an integrated terminal plate and busbar. The secondary battery includes an electrode assembly, a current collection unit electrically coupled to the electrode assembly, a case configured to receive the electrode assembly and the current collection unit, and a terminal unit electrically coupled to the current collection unit, wherein the terminal unit includes an inner terminal portion extending through the case in an inward direction of the case and an outer terminal portion extending in an outward direction of the case, the length of the outer terminal portion being greater than the length of the inner terminal portion.

### TECHNICAL FIELD

The present disclosure relates to a secondary battery and a battery module.

### BACKGROUND ART

A secondary battery is a battery that can be charged and discharged, unlike a primary battery, which cannot be charged. A low-capacity secondary battery may be used in small, portable electronic devices such as smartphones, tablet computers, laptop computers, and vacuum cleaners, whereas a large-capacity secondary battery may be widely used as a power source for driving motors in hybrid vehicles and electric vehicles and as a power storage battery.

The above information disclosed in this Background Art section is only for enhancement of understanding of the background of the present disclosure and therefore it may contain information that does not form the prior art.

### DISCLOSURE

### Technical Problem

The present disclosure provides a terminal plateless secondary battery and a battery module having an integrated terminal plate and busbar.

### Technical Solution

An exemplary secondary battery according to the present disclosure may include an electrode assembly, a current collection unit electrically coupled to the electrode assembly, a case configured to receive the electrode assembly and the current collection unit, and a terminal unit electrically coupled to the current collection unit, wherein the terminal unit includes an inner terminal portion extending through the case in an inward direction of the case and an outer terminal portion extending in an outward direction of the case, the length of the outer terminal portion being greater than the length of the inner terminal portion.

In some examples, the terminal unit may further include a flange portion located on the outside of the case, and the inner terminal portion may extend through the case from the flange portion in the inward direction of the case while the outer terminal portion may extend from the flange portion in the outward direction of the case.

In some examples, the diameter of the flange portion may be greater than the diameter of the inner terminal portion or the diameter of the outer terminal portion.

In some examples, the secondary battery may further include an outer insulating portion interposed between the case and the flange portion.

In some examples, the inner terminal portion may include an inner rivet nut region riveted through the current collection unit.

In some examples, the outer terminal portion may include an outer rivet nut region riveted through a busbar.

In some examples, the length of the outer terminal portion may be greater than the thickness of a busbar coupled to the outer terminal portion.

In some examples, the diameter of the outer terminal portion may be less than the diameter of the inner terminal portion.

In some examples, the terminal unit may be provided on a top side or a lateral side of the case.

In some examples, the case may further include a cap plate, and the terminal unit may be coupled through the cap plate.

A battery module according to the present disclosure includes a first battery including the secondary battery, a second battery located adjacent to the first battery, the second battery including the secondary battery, and a busbar having a first terminal plate coupled to an outer terminal portion of the first battery and a second terminal plate coupled to an outer terminal portion of the second battery.

In some examples, the busbar may include a first through-hole provided in the first terminal plate, the first through-hole being configured to allow the outer terminal portion of the first battery to extend therethrough and be riveted thereto, and a second through-hole provided in the second terminal plate, the second through-hole being configured to allow the outer terminal portion of the second battery to extend therethrough and be riveted thereto.

In some examples, the busbar may include a connection region configured to connect the first terminal plate and the second terminal plate to each other, and the connection region may further include a plurality of strength reinforcement protrusions.

In some examples, the thickness of the connection region may be less than the thickness of each of the first and second terminal plates.

In some examples, the battery module may further include a first insulating plate interposed between the first terminal plate and the first battery and a second insulating plate interposed between the second terminal plate and the second battery.

### Advantageous Effects

The present disclosure may provide a terminal plateless secondary battery by omitting a terminal plate that is coupled to a terminal unit as a separate component on the outside of a case to finish the terminal unit. In addition, the present disclosure may provide a battery module having an integrated terminal plate and busbar by integrally providing a terminal plate at a busbar coupled to the terminal unit.

### DESCRIPTION OF DRAWINGS

FIGS. 1A and 1B are respectively a perspective view and a sectional view showing an exemplary secondary battery according to the present disclosure.

FIG. 1C is a partial cutaway plan view showing an exemplary electrode assembly of the exemplary secondary battery according to the present disclosure.

FIG. 2A is an enlarged view showing region 2a of FIG. 1B.

FIG. 2B is a perspective view showing an exemplary terminal unit of the exemplary secondary battery according to the present disclosure.

FIGS. 3A to 3D are perspective views showing a method of manufacturing an exemplary battery module according to the present disclosure.

FIGS. 4A and 4B are respectively a perspective view and a side view showing an exemplary busbar of the exemplary secondary battery according to the present disclosure.

### BEST MODE

Hereinafter, preferred embodiments of the present disclosure will be described in detail with reference to the accompanying drawings.

The embodiments of the present disclosure are provided to more fully illustrate the present disclosure to a person having ordinary skill in the art to which the present disclosure pertains, the embodiments may be modified in various other forms, and the scope of the present disclosure is not limited to the embodiments. The embodiments are provided to make the disclosure more faithful and complete and to completely convey the idea of the present disclosure fully to those skilled in the art.

Also, in the following drawings, the thickness or size of each layer is exaggerated for convenience and clarity of description and the same reference symbols in the drawings refer to the same elements. As used herein, the term “and/or” includes any one of the enumerated items and any combination of one or more thereof. In addition, as used herein, the term “connected” refers not only to direct connection between members A and B but also to indirect connection between members A and B with member C interposed between members A and B.

The terms used in the specification are intended to describe specific embodiments and are not intended to limit the present disclosure. As used herein, singular forms may include plural forms, unless the context clearly indicates otherwise. In addition, as used herein, the terms “comprise” (or “include”) and/or “comprising” (or “including”) are intended to specify the presence of stated figures, numbers, steps, operations, members, elements, and/or groups thereof and do not exclude the presence or addition of one or more other figures, numbers, steps, operations, members, elements, and/or groups.

While terms such as first and second are used herein to describe various members, parts, regions, layers, and/or portions, the members, the parts, the regions, the layers, and/or the portions are not to be limited by the terms. The terms are used only to distinguish one member, one part, one region, one layer, or one portion from another member, another part, another region, another layer, or another portion. Thus, a first member, a first part, a first region, a first layer, or a first portion hereinafter described may refer to a second member, a second part, a second region, a second layer, or a second portion without departing from the teachings of the disclosure.

Terms related to space, such as “beneath,” “below,” “lower,” “above,” and “upper,” may be utilized to facilitate understanding of one element or feature shown in the drawings as different from another element or feature. The terms related to space are intended to facilitate understanding of the present disclosure in various states of process or use and are not intended to limit the present disclosure. For example, if an element or feature in a figure is inverted, an element or feature described as “beneath” or “below” becomes “above” or “upper.” Thus, “beneath” is a concept that encompasses “above” or “below”.

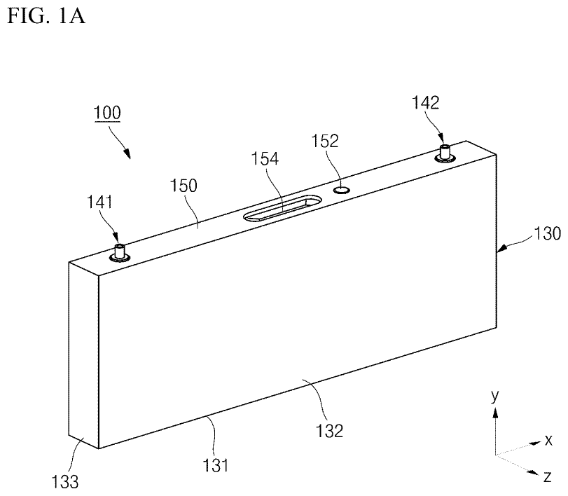

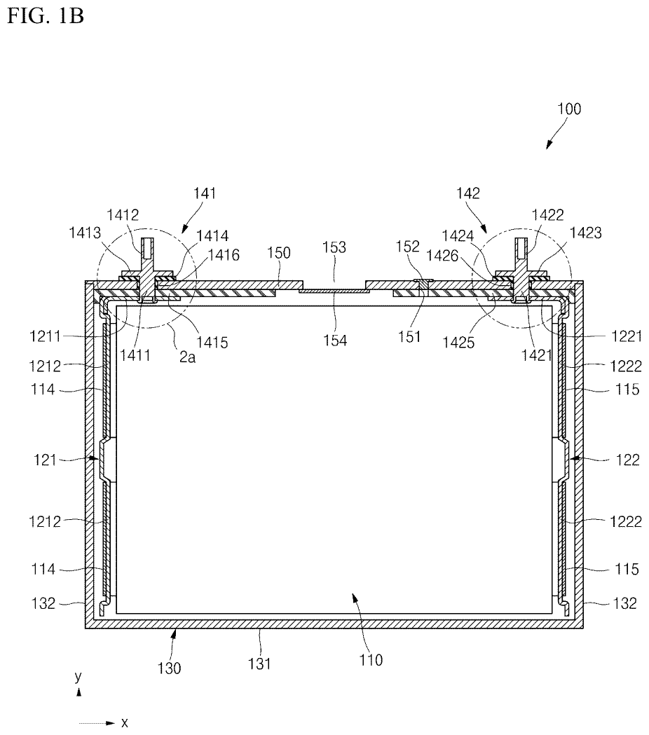

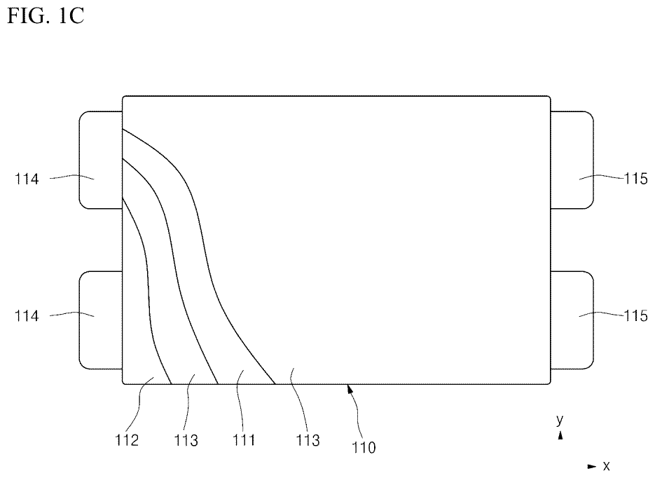

FIGS. 1A and 1B are respectively a perspective view and a sectional view of an exemplary secondary battery 100 according to the present disclosure, and FIG. 1C is a partial cutaway plan view of an exemplary electrode assembly 110 of the exemplary secondary battery 100 according to the present disclosure.

As shown in FIGS. 1A and 1B, the exemplary secondary battery 100 according to the present disclosure may include an electrode assembly 110, current collection units 121 and 122, a case 130, and terminal units 141 and 142. In some examples, the case 130 may be sealed with a cap plate 150, and depending on circumstances, the case 130 may include the cap plate 150. In some examples, the case and cap plate may be referred to as a single case, housing, or cladding.

The electrode assembly 110 may include a first electrode plate 111, a second electrode plate 112, and a separator 113 between the first and second electrode plates 111 and 112 (see FIG. 1C). The electrode assembly 110 may include or be referred to as an electrode group, an electrode stack, or a jelly-roll. In some examples, the electrode assembly 110 may be in the form of a cuboid in which the square first electrode plate 111, the square separator 113, and the square second electrode plate 112 are sequentially stacked. In some examples, the electrode assembly 110 may be provided in the form of a cuboid in which the separator 113 attached to opposite surfaces of the first electrode plate 111, the first electrode plate 111 and the separator 113 are folded together into an approximately “Z” or “S” shape, and the second electrode plate 112 is sandwiched on either side of the zigzag-shaped folded region and stacked.

In this stacked configuration, when the cuboidal electrode assembly 110 is coupled to the approximately cuboidal case 130 having an opening, battery capacity may be significantly increased, since there is little empty space between the electrode assembly 110 and the case 130.

In some examples, the first electrode plate 111 may operate as a positive electrode and the second electrode plate 112 may operate as a negative electrode, or conversely, the first electrode plate 111 may operate as a negative electrode and the second electrode plate 112 may operate as a positive electrode. However, for convenience of description, the present disclosure will be described using an example in which the first electrode plate 111 operates as a positive electrode and the second electrode plate 112 operates as a negative electrode.

In some examples, the first electrode plate 111 may be formed by applying a first electrode active material, such as a transition metal oxide, to a first electrode current collector made of a metal foil, such as aluminum or an aluminum alloy, and may include a first base tab 114, which is a region where the first electrode active material is not applied. The first base tab 114 may be a path for current flow between the first electrode plate 111 and the first current collection unit 121.

In some examples, as shown in FIGS. 1B and 1C, the first base tab 114 may protrude/extend from one side of the electrode assembly 110, may be bent into an approximately “U” shape, and may be connected to the first current collection unit 121, a description of which will follow, while wrapping around a part of the first current collection unit. In some examples, the first base tab 114 of the electrode assembly 110 may originally be flat, but may be bent into an approximately “U” shape so as to be connected to the first current collection unit 121.

The second electrode plate 112 may be formed by applying a second electrode active material, such as graphite or carbon, to a second electrode current collector made of a metal foil, such as copper, a copper alloy, nickel, or a nickel alloy, and may include a second base tab 115, which is a region where the second electrode active material is not applied. The second base tab 115 may be a path for current flow between the second electrode plate 112 and the second current collection unit 122.

In some examples, as shown in FIGS. 1B and 1C, the second base tab 115 may protrude/extend from the other side of the electrode assembly 110, may be bent into an approximately “U” shape, and may be connected to the second current collection unit 122, a description of which will follow, while wrapping around the second current collection unit. In some examples, the second base tab 115 of the electrode assembly 110 may originally be flat, but may be bent into an approximately “U” shape so as to be connected to the second current collection unit 122.

In addition, the first base tab 114 and the second base tab 115 may protrude/extend/be bent from the electrode assembly 110 in a horizontal direction, but may face in opposite directions.

The separator 113 may be located between the first electrode plate 111 and the second electrode plate 112 to prevent short circuit and enable migration of the lithium ions, and may be made of polyethylene, polypropylene, or a composite film of polyethylene and polypropylene. Meanwhile, the present disclosure does not limit the material of the separator 113. Depending on circumstances, the separator 113 may be replaced by a solid electrolyte.

For example, the electrode assembly 110 may be received in the case 130 together with an electrolytic solution; however, the present disclosure is not limited thereto. The electrolytic solution may include an organic solvent, such as ethylene carbonate (EC), propylene carbonate (PC), diethyl carbonate (DEC), ethyl methyl carbonate (EMC), or dimethyl carbonate (DMC), and a lithium salt, such as LiPF₆ or LiBF₄. In addition, the electrolytic solution may be liquid, solid, or gel.

The current collection units 121 and 122 may include a first current collection unit 121 (e.g., a positive electrode current collection unit) and a second current collection unit 122 (e.g., a negative electrode current collection unit). The current collection unit may include or be referred to as a current collection plate, a current collector, or a conduction plate. The first current collection unit 121 may be made of the same material as the first base tab 114. In some examples, if the first base tab 114 is made of an aluminum-based material, the first current collection unit 121 may also be made of an aluminum-based material. Consequently, the first current collection unit 121 and the first base tab 114 may be easily welded to each other.

In some examples, the first current collection unit 121 may include a first section 1211 coupled to the first terminal unit 141 and a second section 1212 coupled to the first section 1211. The first section 1211 may be provided between the electrode assembly 110 and the cap plate 150 in a shape that is approximately parallel to a width direction (e.g., an x-x direction) of the electrode assembly 110, and the second section 1212 may be provided on one side of the electrode assembly 110 in a direction (i.e., a height direction) (i.e., a y-y direction) that is approximately perpendicular to the width direction of the electrode assembly 110. In some examples, the first base tab 114 may be welded to the second section 1212 while wrapping around the second section 1212.

The second current collection unit 122 may be made of the same material as the second base tab 115. In some examples, if the second base tab 115 is made of a copper-based material or a nickel-based material, the second current collection unit 122 may also be made of a copper-based material or a nickel-based material. Consequently, the second current collection unit 122 and the second base tab 115 may be easily welded to each other.

In some examples, the second current collection unit 122 may include a first section 1221 coupled to the second terminal unit 142 and a second section 1222 coupled to the first section 1221. The first section 1221 may be provided between the electrode assembly 110 and the cap plate 150 in a shape that is approximately parallel to the width direction of the electrode assembly 110, and the second section 1222 may be provided on the other side of the electrode assembly 110 in the direction (i.e., the height direction) that is approximately perpendicular to the width direction of the electrode assembly 110. In some examples, the second base tab 115 may be welded to the second section 1222 while wrapping around the second section 1222.

The case 130 may be in the form of a hollow, approximately cuboidal shape having an opening formed at the top thereof. Consequently, the electrode assembly 110 and the current collection units 121 and 122 may be inserted into the case 130 through the opening. The case may include or be referred to as a can, housing, or cladding. The case 130 may include a bottom portion 131, a pair of long side portions 132, and a pair of short side portions 133 connecting the pair of long side portions 132, wherein the opening may be provided in the side opposite the bottom portion 131. In some examples, the case 130 may be made of an aluminum-based material or a stainless-steel-based material, and may be manufactured by a deep drawing process or by a bending and welding process.

The cap plate 150 may be provided in an approximately flat shape, and may be coupled (e.g., welded) to the opening of the case 130 to seal the opening. The cap plate may include or be referred to as a cap assembly, lid, or cover. The cap plate 150 may include an injection hole 151 configured to allow an electrolytic solution to be injected into the sealed case 130 therethrough and a seal stopper 152 configured to close the electrolyte injection hole 151. In addition, the cap plate 150 may include a vent hole 153 and a vent plate 154 coupled to the vent hole 153, the vent plate being configured to rupture when the inner pressure of the case 130 is equal to or higher than a set pressure. The cap plate 150 may be made of a material identical or similar to the material of the case 130.

The terminal units 141 and 142 may include a first terminal unit 141 (e.g., a positive electrode terminal unit) and a second terminal unit 142 (e.g., a negative electrode terminal unit). The terminal unit may include or be referred to as a terminal, terminal post, or terminal region. The first terminal unit 141 may be made of the same material as the first current collection unit 121. In some examples, if the first current collection unit 121 is made of an aluminum-based material, the first terminal unit 141 may also be made of an aluminum-based material. In some examples, the first terminal unit 141 may include an inner terminal portion 1411, an outer terminal portion 1412, and a flange portion 1413. The inner terminal portion 1411 may extend through the case 130 (or the cap plate 150) in an inward direction of the case 130, the outer terminal portion 1412 may extend in an outward direction of the case 130 (or the cap plate 150), and the flange portion 1413 may be seated on the outside of the case 130 (or the cap plate 150). In some examples, the length of the outer terminal portion 1412 may be greater than the length of the inner terminal portion 1411. In some examples, an outer insulating portion 1414 may be interposed between the flange portion 1413 and the cap plate 150, an inner insulating portion 1415 may be interposed between the first current collection unit 121 and the cap plate, and a sealing gasket 1416 may be interposed between the inner terminal portion 1411 and the cap plate 150.

The second terminal unit 142 may be made of a different material than the second current collection unit 122. In some examples, if the second current collection unit 122 is made of a copper-based material or a nickel-based material, the second terminal unit 142 may be made of an aluminum-based material. In some examples, the second terminal unit 142 may include an inner terminal portion 1421, an outer terminal portion 1422, and a flange portion 1423. The inner terminal portion 1421 may extend through the case 130 (or the cap plate 150) in the inward direction of the case 130, the outer terminal portion 1422 may extend in the outward direction of the case 130 (or the cap plate 150), and the flange portion 1423 may be seated on the outside of the case 130 (or the cap plate 150). In some examples, the length of the outer terminal portion 1422 may be greater than the length of the inner terminal portion 1421. In some examples, an outer insulating portion 1424 may be interposed between the flange portion 1423 and the cap plate 150, an inner insulating portion 1425 may be interposed between the second current collection unit 122 and the cap plate, and a sealing gasket 1426 may be interposed between the inner terminal portion 1421 and the cap plate 150.

Substantially, the first terminal unit 141 and the second terminal unit 142 may be similar or identical in shape and material. Consequently, one of the terminal units will be described in more detail as a representative example.

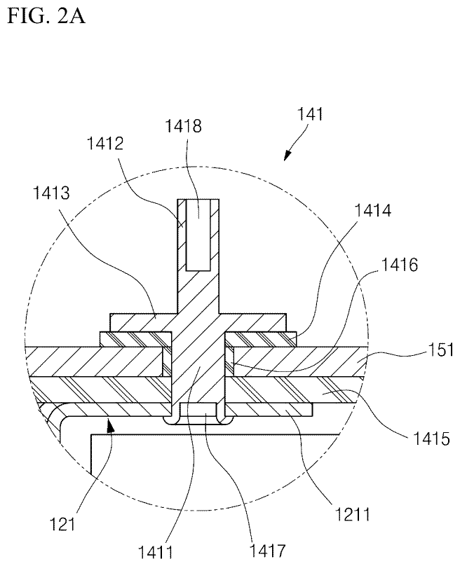

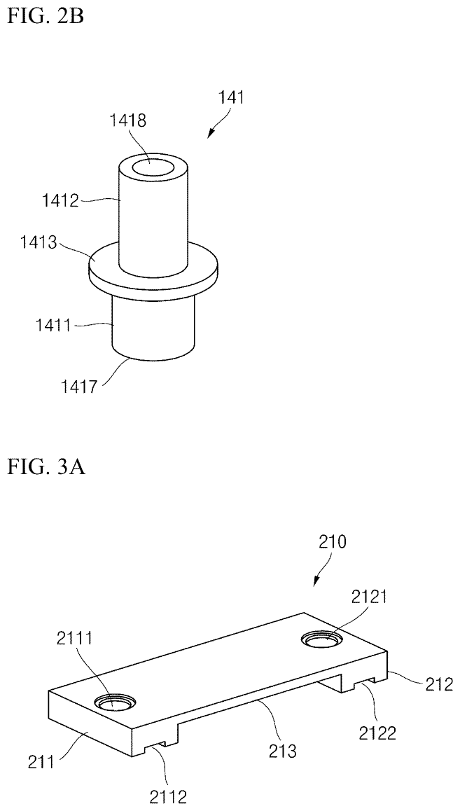

FIG. 2A is an enlarged view of region 2a of FIG. 1B, and FIG. 2B is a perspective view of an exemplary terminal unit 141 of the exemplary secondary battery 100 according to the present disclosure.

As shown in FIGS. 2A and 2B, the exemplary terminal unit 141 according to the present disclosure may include an inner terminal portion 1411 extending through the cap plate 150 in the inward direction of the case 130, an outer terminal portion 1412 extending in the outward direction of the case 130, and a flange portion 1413 located at the outside of the cap plate 150 between the inner terminal portion 1411 and the outer terminal portion 1412.

In some examples, the inner terminal portion 1411 and/or the outer terminal portion 1412 may be approximately cylindrical in shape, and the flange portion 1413 may be approximately disk-shaped. In some examples, the diameter of the flange portion 1413 may be greater than the diameter of the inner terminal portion 1411 and/or the diameter of the outer terminal portion 1412. In some examples, an outer insulating portion 1414 may be interposed between the flange portion 1413 and the cap plate 150 and may wrap around a part of the inner terminal portion 1411. In some examples, a lower insulating portion 1415 may be interposed between the cap plate 150 and the first current collection unit 121 and may wrap around a part of the inner terminal portion 1411. A sealing gasket 1416 is located on the inside of the cap plate 150 and may wrap around a part of the inner terminal portion 1411.

In some examples, the inner terminal portion 1411 may include an inner rivet nut region 1417 that is riveted through the current collection unit 121. The inner rivet nut region 1417 may include a depressed shape from the bottom toward the top. In some examples, the outer terminal portion 1412 may include an outer rivet nut region 1418 that is riveted through a busbar. The outer rivet nut region 1418 may include a depressed shape from the top toward the bottom.

In some examples, the length of the outer terminal portion 1412 may be greater than the length of the inner terminal portion 1411 and may be greater than (or longer than) the thickness of the busbar riveted to the outer terminal portion 1412.

In some examples, the diameter of the outer terminal portion 1412 may be less than the diameter of the inner terminal portion 1411. In some examples, the diameter of the inner terminal portion 1411 may be greater than the diameter of the outer terminal portion 1412. In some examples, the diameter of the outer terminal portion 1412 and the diameter of the inner terminal portion 1411 may be similar or equal.

In some examples, the terminal units 141 and 142 may be provided on a top side of the case 130 (or the cap plate 150), and a battery including the terminal units 141 and 142 may be referred to as a battery having a top terminal. In some examples, the terminal units 141 and 142 may be provided on a lateral side of the case 130 (or the cap plate 150), and a battery including the terminal units 141 and 142 may be referred to as a battery having a lateral terminal.

As a result, the secondary battery 100 according to the present disclosure does not have a terminal plate that is coupled to the terminal units 141 and 142 as a separate component on the outside of the case 130 and/or the cap plate 150 to finish the terminal units 141 and 142. That is, the present disclosure may provide a terminal plateless secondary battery 100.

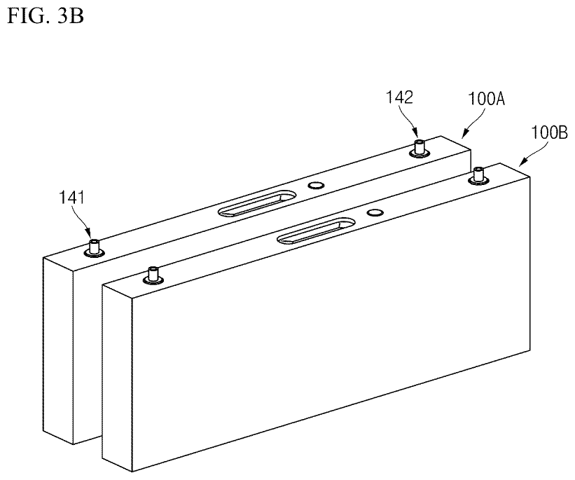

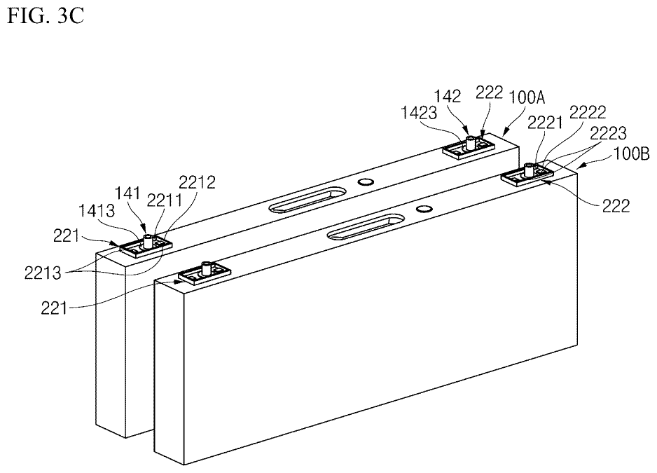

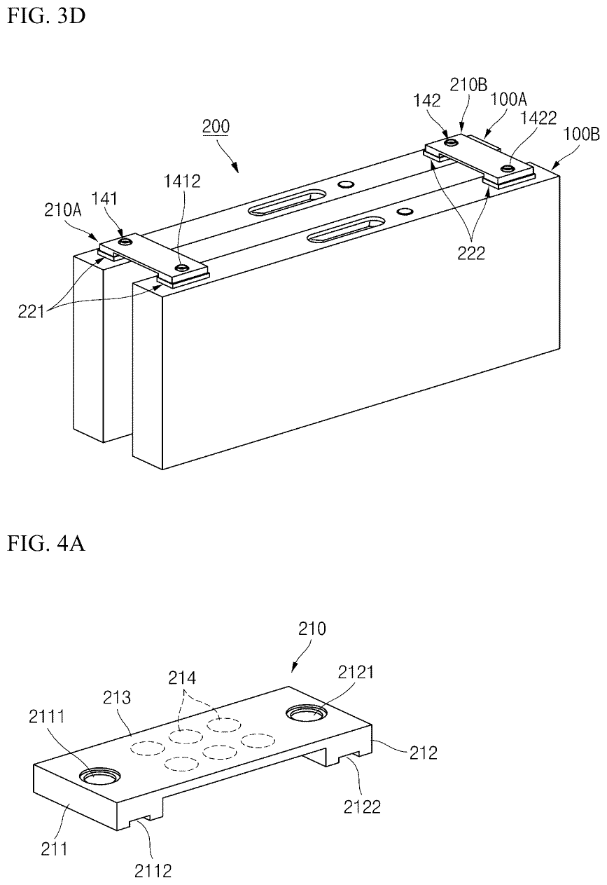

FIGS. 3A to 3D are perspective views showing a method of manufacturing an exemplary battery module 200 according to the present disclosure.

As shown in FIG. 3A, a busbar 210 in the form of an approximately flat plate may be provided.

The material of the busbar 210 may be similar or identical to the material of the terminal unit. The busbar 210 may include a first terminal plate 211 having a first through-hole 2111 into which one terminal unit is fitted, a second terminal plate 212 having a second through-hole 2121 into which the other terminal unit is fitted, and a connection region 213 configured to connect the first terminal plate 211 and the second terminal plate 212 to each other. The thickness of the connection region 213 may be less than the thickness of each of the first and second terminal plates 211 and 212. In some examples, the first terminal plate 211 may further include a first recess 2112 provided in a lower surface thereof, and the second terminal plate 212 may further include a second recess 2122 provided in a lower surface thereof.

As shown in FIG. 3B, secondary batteries may be provided.

In some examples, a first battery 100A similar or identical to the secondary battery 100 and a second battery 100B located adjacent to the first battery 100A and similar or identical to the secondary battery 100 may be provided.

As shown in FIG. 3C, insulating plates 221 and 222 may be provided.

In some examples, the first insulating plate 221 is located on the cap plate 150 as the outside of one terminal unit 141 (e.g., the flange portion 1413).

In some examples, the first insulating plate 221 may be in the form of an approximately rectangular plate that approximately corresponds to each of the first and second terminal plates 211 and 212 of the busbar 210. Specifically, the first insulating plate 221 may include a bottom portion 2211 having an opening, to which the flange portion 1413 is coupled, formed in the inside thereof, the bottom portion being in contact with the cap plate 150, a sidewall portion 2212 in the form of a square line (when viewed in plan) extending upward from the perimeter of the bottom portion 2211, and protrusions 2213 provided oppositely from the sidewall portion 2212 toward the flange portion 1413. In some examples, the protrusions 2213 may be provided on the bottom portion 2211 oppositely in a longitudinal direction (e.g., an x-x direction) of the cap plate 150.

In some examples, a second insulating plate 222 may be provided on the cap plate 150 as the outside of the other terminal unit 142 (e.g., the flange portion 1423). Specifically, the second insulating plate 222 may include a bottom portion 2221 having an opening, to which the flange portion 1423 is coupled, formed in the inside thereof, the bottom portion being in contact with the cap plate 150, a sidewall 2222 in the form of a square line (when viewed in plan) extending upward from the perimeter of the bottom portion 2221, and protrusions 2223 provided oppositely from the sidewall 2222 toward the flange portion 1423. In some examples, the protrusions 2223 may be provided on the bottom portion 2221 oppositely in the longitudinal direction (e.g., the x-x direction) of the cap plate 150.

As shown in FIG. 3D, busbars 210A and 210B may be provided.

In some examples, the terminal unit 141 of the first battery 100A and the terminal unit 141 of the second battery 100B may be coupled to each other via the busbar 210A. In some examples, the terminal unit 141 (e.g., the outer terminal portion 1412) of the first battery 100A may be loosely coupled to the first through-hole 2111 of the first terminal plate 211 of the busbar 210A, and the terminal unit 141 (e.g., the outer terminal portion 1412) of the second battery 100B may be loosely coupled to the second through-hole 2121 of the second terminal plate 212 of the busbar 210A. Subsequently, a riveting process may be performed between the outer terminal portion 1412 of the terminal unit 141 of each of the first and second batteries 100A and 100B and the first terminal plate 211, and between the outer terminal portion 1412 of the terminal unit 141 and the second terminal plate 211, respectively, whereby the first and second batteries 100A and 100B may be mechanically/electrically coupled to each other via the busbar 210A. In some examples, the first insulating plate 221 may be interposed between the busbar 210A and the cap plate 150 of each of the first and second batteries 100A and 100B, whereby the busbar 210A may be insulated from the case 130 and/or the cap plate 150. In some examples, not only a riveting process but also a laser welding process may be further performed on the perimeter of the terminal unit 141 (e.g., the outer terminal portion 1412) coupled to the first through-hole 2111 of the first terminal plate 211 of the busbar 210A and the perimeter of the terminal unit 141 (e.g., the outer terminal portion 1412) coupled to the second through-hole 2121 of the second terminal plate 212 of the busbar 210A, respectively, whereby the strength of electrical/mechanical coupling between the busbar 210A and the terminal unit 141 may be further improved.

In some examples, the terminal unit 142 of the first battery 100A and the terminal unit 142 of the second battery 100B may be coupled to each other via the busbar 210B. In some examples, the terminal unit 142 (e.g., the outer terminal portion 1422) of the first battery 100A may be loosely coupled to the first through-hole 2111 of the first terminal plate 211 of the busbar 210B, and the terminal unit 142 (e.g., the outer terminal portion 1422) of the second battery 100B may be loosely coupled to the second through-hole 2121 of the second terminal plate 212 of the busbar 210B. Subsequently, a riveting process may be performed between the outer terminal portion 1422 of the terminal unit 142 of each of the first and second batteries 100A and 100B and the first terminal plate 211, and between the outer terminal portion 1422 of the terminal unit 142 and the second terminal plate 211, respectively, whereby the first and second batteries 100A and 100B may be mechanically/electrically coupled to each other via the busbar 210B. In some examples, the second insulating plate 222 may be interposed between the busbar 210B and the cap plate 150 of each of the first and second batteries 100A and 100B, whereby the busbar 210B may be insulated from the case 130 and/or the cap plate 150. In some examples, not only a riveting process but also a laser welding process may be further performed on the perimeter of the terminal unit 142 (e.g., the outer terminal portion 1422) coupled to the first through-hole 2111 of the first terminal plate 211 of the busbar 210B and the perimeter of the terminal unit 142 (e.g., the outer terminal portion 1422) coupled to the second through-hole 2121 of the second terminal plate 212 of the busbar 210B, respectively, whereby the strength of electrical/mechanical coupling between the busbar 210B and the terminal unit 142 may be further improved.

Although parallel connection between the first and second batteries 100A and 100B using the busbars 210A and 210B is described herein, series connection therebetween may be similarly performed.

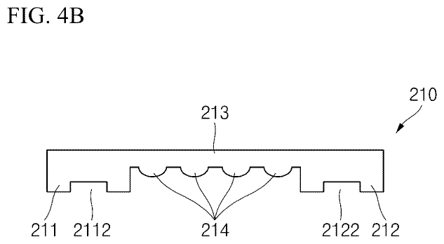

FIGS. 4A and 4B are respectively a perspective view and a side view showing an exemplary busbar 210 of the exemplary secondary battery 100 according to the present disclosure.

As shown in FIGS. 4A and 4B, the busbar 210 may further include a plurality of strength reinforcement protrusions 214 provided in the connection region 213 connecting the first terminal plate 211 and the second terminal plate 212. In some examples, upper surfaces of the first and second terminal plates 211 and 212 and the third region 213 may all be flat, and lower surfaces of the first and second terminal plates 211 and 212 and the third region 213 may not be flat. In some examples, the plurality of strength reinforcement protrusions 214 may be provided on the lower surface of the connection region 213. In some examples, the thickness of the connection region 213 including the plurality of strength reinforcement protrusions 214 may be less than the thickness of each of the first and second terminal plates 211 and 212. The plurality of strength reinforcement protrusions 214 may prevent damage to the busbar 210 in the event of expansion or deformation of the secondary battery 100.

In some examples, the first terminal plate 211 may further include a recess 2112 provided in the lower surface thereof. The recess 2112 may include a depressed shape from the bottom toward the top of the first terminal plate 211. In some examples, the first terminal plate 211 may be coupled to the bottom portion 2211 and the sidewall portion 2212 of the first insulating plate 221, and the recess 2112 of the first terminal plate 211 may also be coupled to the protrusion 2213 of the first insulating plate 221. Consequently, the strength of coupling between the first terminal plate 211 and the first insulating plate 221 of the busbar 210 may be improved.

In some examples, the second terminal plate 212 may further include a recess 2122 provided in the lower surface thereof. The recess 2122 may include a depressed shape from the bottom toward the top of the second terminal plate 212. In some examples, the second terminal plate 212 may be coupled to the bottom portion 2221 and the sidewall portion 2222 of the second insulating plate 222, and the recess 2122 of the second terminal plate 212 may also be coupled to the protrusion 2223 of the first insulating plate 222. Consequently, the strength of coupling between the second terminal plate 212 and the second insulating plate 222 of the busbar 210 may be improved.

As a result, the present disclosure may provide a battery module having an integrated terminal plate and busbar. To put it differently, in the present disclosure, the terminal plate may be integrally formed at the busbar instead of providing the terminal plate at the secondary battery, whereby it is possible to reduce the number of components and material costs in the secondary battery and the battery module and to simplify a manufacturing process.

The above is only an embodiment for implementing the exemplary secondary battery and the exemplary battery module according to the present disclosure, the present disclosure is not limited to the above embodiment, and a person having ordinary skill in the art to which the present disclosure pertains will recognize the technical spirit of the present disclosure to the extent that various modifications can be made without departing from the gist of the present disclosure as claimed in the following claims.

1. A secondary battery comprising:
an electrode assembly;
a current collection unit electrically coupled to the electrode assembly;
a case configured to receive the electrode assembly and the current collection unit; and
a terminal unit electrically coupled to the current collection unit, wherein
the terminal unit comprises an inner terminal portion extending through the case in an inward direction of the case and an outer terminal portion extending in an outward direction of the case, a length of the outer terminal portion being greater than a length of the inner terminal portion.

2. The secondary battery as claimed in claim 1, wherein
the terminal unit further comprises a flange portion located on an outside of the case, and
the inner terminal portion extends through the case from the flange portion in the inward direction of the case while the outer terminal portion extends from the flange portion in the outward direction of the case.

3. The secondary battery as claimed in claim 2, wherein a diameter of the flange portion is greater than a diameter of the inner terminal portion or a diameter of the outer terminal portion.

4. The secondary battery as claimed in claim 2, further comprising an outer insulating portion interposed between the case and the flange portion.

5. The secondary battery as claimed in claim 1, wherein the inner terminal portion comprises an inner rivet nut region riveted through the current collection unit.

6. The secondary battery as claimed in claim 1, wherein the outer terminal portion comprises an outer rivet nut region riveted through a busbar.

7. The secondary battery as claimed in claim 1, wherein a length of the outer terminal portion is greater than a thickness of a busbar coupled to the outer terminal portion.

8. The secondary battery as claimed in claim 1, wherein a diameter of the outer terminal portion is less than a diameter of the inner terminal portion.

9. The secondary battery as claimed in claim 1, wherein the terminal unit is provided on a top side or a lateral side of the case.

10. The secondary battery as claimed in claim 1, wherein the case further comprises a cap plate, and the terminal unit is coupled through the cap plate.

11. A battery module comprising:
a first battery comprising the secondary battery as claimed in claim 1;
a second battery located adjacent to the first battery, the second battery comprising the secondary battery as claimed in claim 1; and
a busbar having a first terminal plate coupled to an outer terminal portion of the first battery and a second terminal plate coupled to an outer terminal portion of the second battery.

12. The battery module as claimed in claim 11, wherein the busbar comprises a first through-hole provided in the first terminal plate, the first through-hole being configured to allow the outer terminal portion of the first battery to extend therethrough and be riveted thereto, and a second through-hole provided in the second terminal plate, the second through-hole being configured to allow the outer terminal portion of the second battery to extend therethrough and be riveted thereto.

13. The battery module as claimed in claim 11, wherein the busbar comprises a connection region configured to connect the first terminal plate and the second terminal plate to each other, and the connection region further comprises a plurality of strength reinforcement protrusions.

14. The battery module as claimed in claim 13, wherein a thickness of the connection region is less than a thickness of each of the first and second terminal plates.

15. The battery module as claimed in claim 11, further comprising a first insulating plate interposed between the first terminal plate and the first battery and a second insulating plate interposed between the second terminal plate and the second battery.
